(19) United States
(12) Patent Application Publication
(10) Pub. No.: US 2009/0050777 A1
(43) Pub. Date: Feb. 26, 2009

(54) TREE STAND

(76) Inventor: Harold A. Odom, JR., Missouri City, TX (US)

Correspondence Address: WINSTEAD PC, P.O. BOX 50784, DALLAS, TX, 75201, US

(21) Appl. No.: 11/844,187

(22) Filed: Aug. 23, 2007

(51) Int. Cl. F16M 13/00

(52) U.S. Cl. 248/523

(57) ABSTRACT

For cut Christmas tree trunk, wood or metal pole or the like, a stand having telescoping and locking adjustable supports which can be adjusted to move and retain the Christmas tree trunk, wood or metal pole or the like in the braced desired vertical position while in the case of a harvested tree avoiding interference by branches. The stand base provides for a reservoir for the water or other nutrients necessary for safe enjoyment of a cut Christmas tree. The stand base effective support diameter is extendable by the use of attachable members to increase stability of the Christmas tree trunk, wood or metal pole or the like being displayed. The use of additional locking and telescoping bracing supports attached to the extending members allow for additional angular bracing of taller Christmas tree trunks, wood or metal poles or the like.

### FIELD OF INVENTION

The present disclosure relates in general to a device and method for displaying harvested and artificial trees, poles and the like.

### BACKGROUND OF THE INVENTION

Devices designed for the display of Christmas trees generally enable users to properly stand the tree vertically and insure that once positioned, the tree will most likely remain in such a position. This arrangement is highly desirable because of the dangers associated with an accidental tipping of the tree, such as possibly breaking electric light bulbs, the highly combustible nature of Christmas trees when exposed to sources of ignition, and the expense of correcting any damage that could result from any accidental tipping of the tree, including damage to decorations and spills from reservoirs used to supply water and nutrients.

A number of devices have been developed that operate effectively only by removing a substantial portion of side branches around the trunk. A connecting means is typically limited to bracing the tree only to the height that the branches have been removed in these systems.

Other devices that have been developed provide screws to attach fixed length braces to the tree only after the tree has been placed in the intended vertical position. Such devices generally require all the screws to all the braces be removed in order to perform any subsequent refinement to the adjustment of the vertical position.

One particular device uses a movable receptacle for the cut end of the tree in combination with a series of springs and chains to accomplish vertical display. Though the receptacle can be positioned to accommodate crooked trunks, the clamp bolts must be all loosened in order to move the receptacle to a new position to adjust the displayed tree to a more desired position. This new position is totally dependent on the resistance of opposing springs to maintain the position selected. The size of the reservoir is limited by the amount of free travel necessary along each of the guideways needed to accomplish adjustment. This limitation also limits the size of the tree trunk which can be placed in the stand.

In view of the foregoing, there is a need for the development of a device which may position a display tree in a substantially vertical position that is readily adjustable and does not require the exfoliation of considerable amounts of side branches, which detracts from the aesthetic look of the tree.

### BRIEF DESCRIPTION OF THE DRAWINGS

For a detailed understanding of the present invention, reference is made to the accompanying Figures, wherein:

FIG. 1 shows a perspective view of the stand device in accordance with embodiments of the present invention.

FIG. 2 shows a plan view with extendable supports retracted in accordance with embodiments of the present invention.

FIG. 3 shows a plan view with extendable support assembly extended in accordance with embodiments of the present invention.

FIG. 4 shows a side view of a typical telescoping bracing supports and typical extendable support assembly in accordance with embodiments of the present invention.

FIG. 5 shows a cross-section view of an integral reservoir and spike support in accordance with embodiments of the present invention.

FIG. 6 shows detail of an upper swivel hinge and lower swivel ring in accordance with embodiments of the present invention.

FIG. 7 shows a perspective view of the stand device in accordance with embodiments of the present invention.

FIG. 8 shows a side view of typical telescoping bracing supports and stand device with cross-member configuration.

FIG. 9 shows side view of a cross-member with extension rail and base extension.

FIG. 10 shows a cross-section view of extension support assembly.

FIG. 11 shows a plan view of the stand device with cross-members attached to a separate reservoir.

FIG. 12 shows a plan view of the stand device with interlocking cross-members.

FIG. 13 shows a cross-section of a separate reservoir.

FIG. 14 shows a cross-section of a separate reservoir without an integral spike assembly.

FIG. 15 shows cross-section and plan views of stand device with hinged cross members.

### SUMMARY OF THE INVENTION

The present disclosure describes a device for erecting and displaying harvested and artificial Christmas trees, wood and metal poles and the like. The device includes a base, pivot assembly to engage and stabilize the near center of the bottom of the item to be displayed and the near center of the base, at least three telescoping and releasably locking bracing supports fitted with an attachment means that is optionally swiveling on each end. Attachment at one end is coupled on the outer perimeter of a base and a removable attachment at the other end attached to a tree trunk, wood or metal pole or the like at an angle to brace and hold the item and prevent the item displayed from tipping. In the case of a cut Christmas tree, the stand can include a reservoir for water and other nutrients needed by a tree to stay fresh and safe.

### DETAILED DESCRIPTION OF THE INVENTION

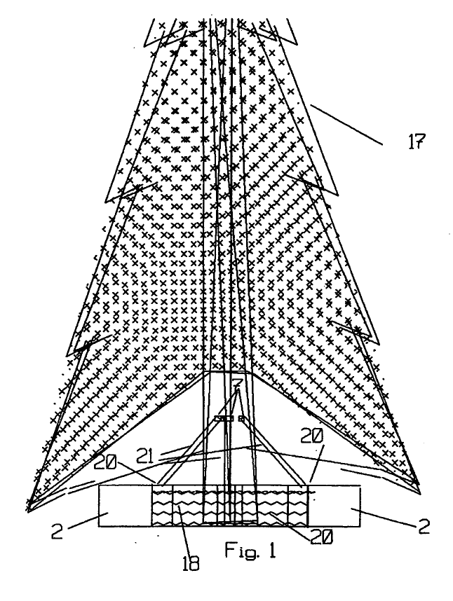

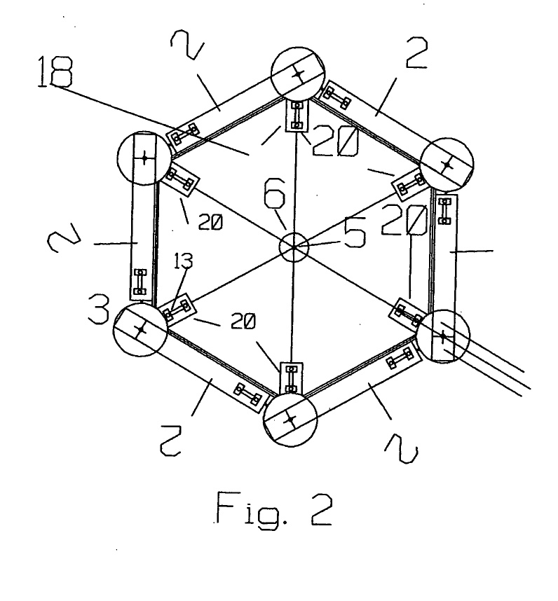

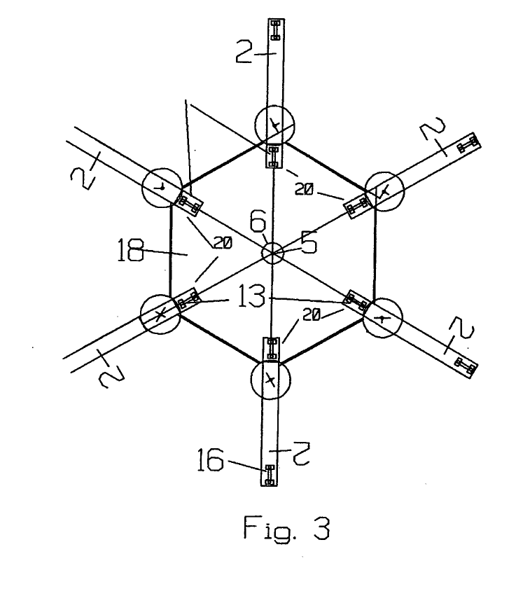

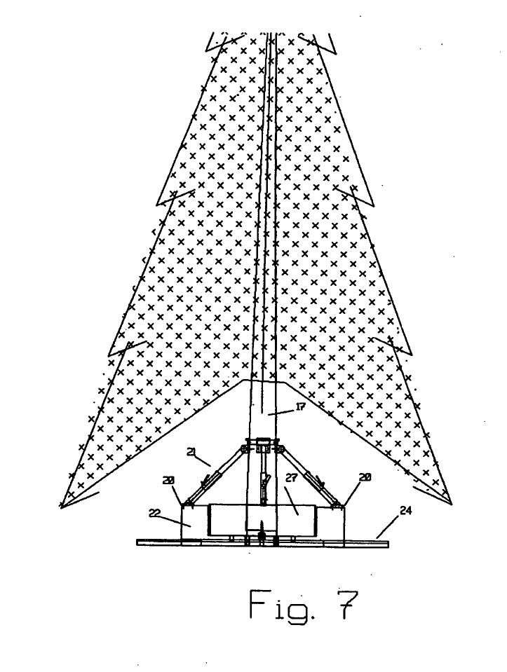

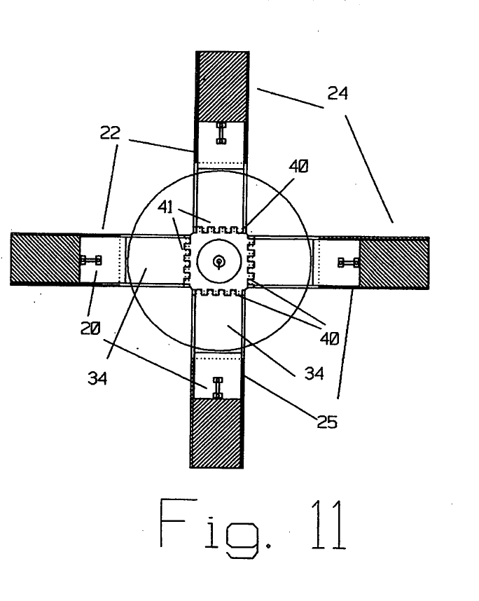

With reference now to the drawings (FIGS. 1-15) the stand device disclosed herein is described. For illustrative purpose specific dimensions and materials may be listed, but the invention is not considered to be so limited. In accordance with various embodiments, FIG. 1 shows a stand (1) that has as a base an integral reservoir (18) around which at least three attachment points (20) as shown in FIGS. 2 and 3 are equally spaced from each other and each equally spaced from the center of the integral reservoir (18) and at least three telescoping bracing supports (21) attached to each of the attachment points (20) and the other end attached to at least three points spaced approximately equidistant around the trunk. An alternate embodiment of the present invention as shown in FIG. 7 shows a base that does not include an integral reservoir (18) type function which base has four attachment points (20) as shown in FIG. 11 equally spaced from each other and each equally spaced from the center of the separate reservoir (27) and four telescoping bracing supports (21) attached to each of the attachment points (20) and the other end attached to four points spaced approximately equidistant around the trunk. Telescoping and locking legs used as part of a stand device have been described. See, for example, U.S. Pat. Nos. 7,124,985, 6,536,723, 6,920,834, 7,176,366, 3,164,351 and 676,362, all of which are hereby fully incorporated by reference.

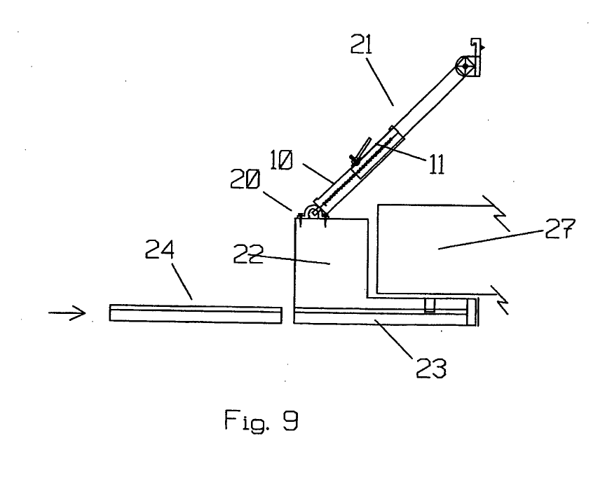

The elevated platform (22) as shown in FIG. 9 provides a raised plane for an attachment point (20) for the telescoping bracing supports (21) which allows the telescoping bracing supports (21) to reach higher up the tree corresponding to the height of the elevated platform (22) while maintaining the desired angle of support necessary to hold the tree (17). The elevation additionally allows a deeper reservoir to be placed under the telescoping bracing supports (21) thereby providing increased water capacity to the tree (17).

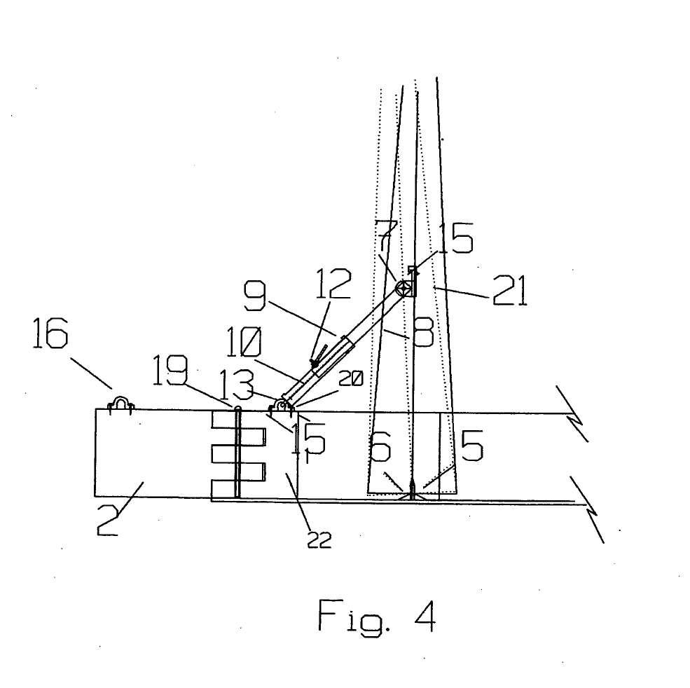

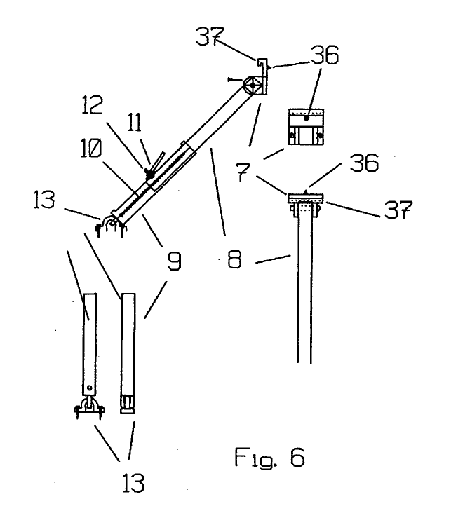

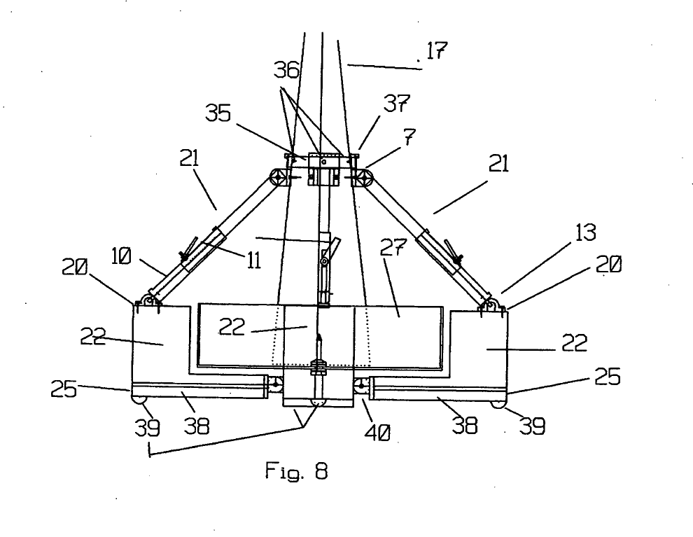

As shown in FIG. 6 the telescoping inner member (8) is fitted with an upper support swivel hinge (7) on the end that attaches to the tree and the telescoping outer member (9) is fitted with a lower support swivel ring (13) on the end that attaches to the attachment point (20). As shown in FIG. 4 each lower support ring (13) attaches to an attachment point (20) and each upper support swivel hinge (7) attaches to the trunk to create the telescoping bracing support (21). As shown in FIG. 4 and FIG. 8 the telescoping inner member (8) is designed to move laterally within telescoping tube outer member (9) and a releasable locking mechanism (11) is used to retain the selected length of the telescoping bracing support (21). Telescoping means can be accomplished by any shape of material that allows one member to be move laterally within another.

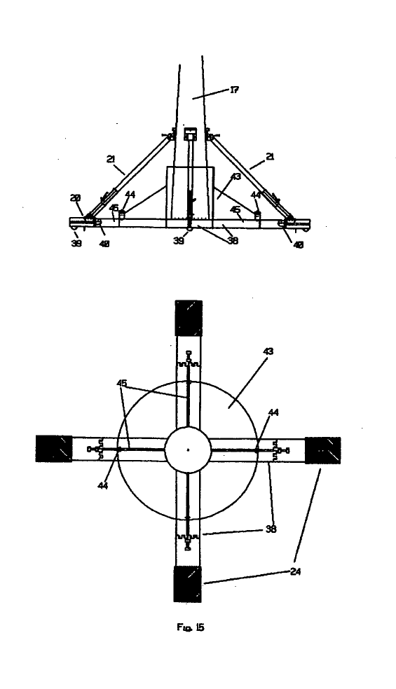

Attachment of the telescoping bracing support (21) to a tree can be accomplished as shown in FIG. 15 with the use of removable means such as wood screws to attach the upper support swivel hinge (7) and in FIG. 8 using a removable adjustable collar means that when tightened around the trunk the upper support swivel hinge (7) is retained at the desired point to brace the tree. When a band clamp is used as a collar the tightening of the band clamp then causes the barb (36) of the upper support swivel hinge (7) to penetrate the tree to provide additional stability of the position selected for bracing. Each upper support swivel hinge (7) can be fitted to a “C” type clamp so that when each clamp is applied to the tree each upper support swivel hinge (7) is attached at the desired point to brace the tree. While these methods have been described, these components are exemplary and other mechanical equivalent means can be substituted.

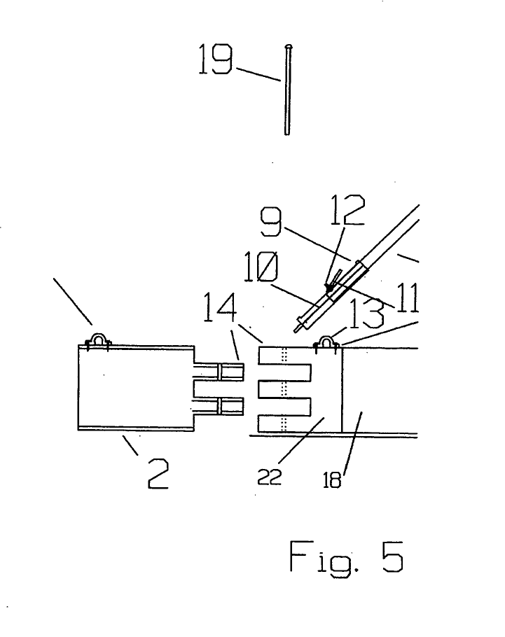

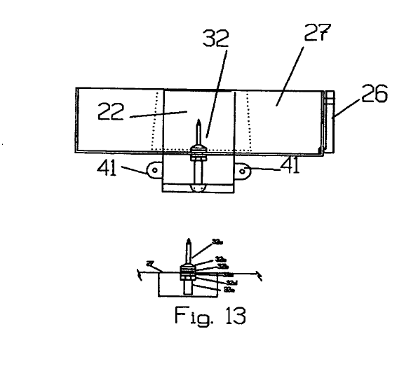

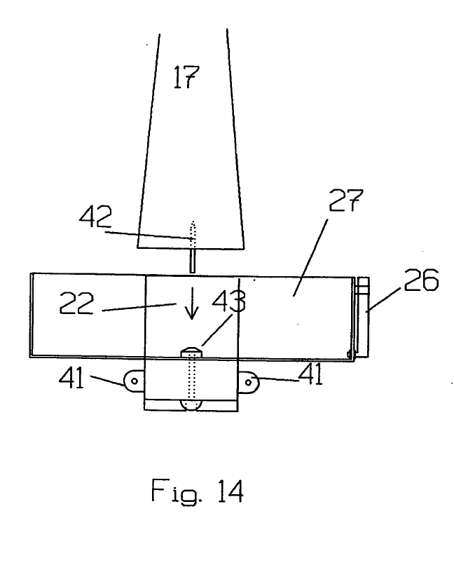

FIG. 5 and FIG. 13 show a spike (5) and spike assembly (32) respectively upon which the trunk of a Christmas tree is impaled used to provide the pivot point against which the telescoping bracing supports (21) react. FIG. 14 shows a spike (42) that has been driven into the near center of the cut end of the trunk tree (17) used to provide the pivot point against which the telescoping bracing supports (21) reacts. Once the tree (17) has been impaled on the spike assembly (32), or as shown in FIG. 14 the spike (42) has been driven into the tree (17) and the exposed end of the spike (42) has been received into the center hole of the cam node (43), and the other end of each of the telescoping bracing supports (21) has been attached to the tree (17) and temporarily locked, the tree (17) and stand (1) can be placed so that stand (1) sits on the floor and any necessary adjustment can be made to the vertical position of the tree (17) by disengaging the locking mechanism (11) of each of the telescoping bracing supports (21) and moving the tree (17) in the desired direction for a more desirable vertical position then engaging the releasable locking mechanism (11) of each telescoping bracing support (21) to hold the tree (17) in the selected position. The present invention (1) as shown in FIGS. 2 and 3 provides for at least three (3) pivotable extension arm (2) which pivot away from the integral reservoir (18) wall on the same plane as the floor of the bottom side of the integral reservoir (18) to extend the stand base effective support diameter.

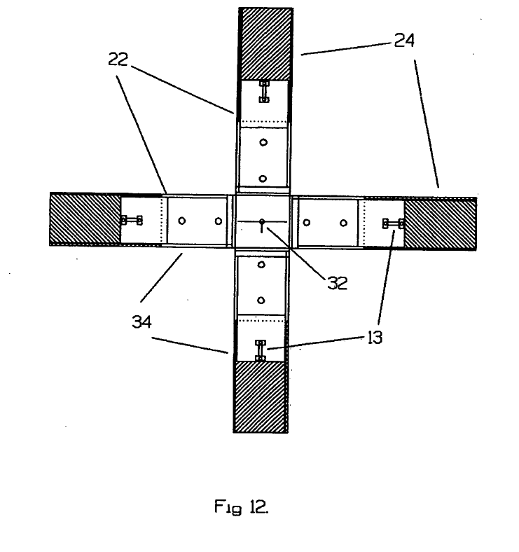

The alternate embodiment of the stand (1) as shown in FIG. 7 employs two interlocking cross members (34) as shown in FIG. 12 to create a platform base on which a separate reservoir can be fitted. As shown in FIGS. 9, 10, 11 and 12 the underside of the interlocking cross members (34) is fitted with an extension support assembly (25) which is comprised of an extension rail (23) and a base extension (24) to slide outwardly along the extension rail (23) to provide expansion of the effective diameter of the stand (1) for increased stability of the tree being displayed in the stand (1). An alternate embodiment of the stand (1) employs retractable telescoping extensions that are parallel to the floor and have contact points that are on the same plane as the bottommost side of the stand (1) to the floor. The stand is easily disassembled at the end of the season for storage.

As shown in FIG. 11 and FIG. 8 the cross member (38) is fitted with a hinge assembly (40) to interlock the cross members (34) which allows the foot (39) of the hinged cross member (38) to remain in engagement with the floor when the stand (1) is used where floors are not exactly level in the place where it is desirable to display a tree. The reservoir (27) as shown in FIGS. 11 and 13 provides interlocking members (41) which after the hinged cross member (38) is placed and aligned a pin can be inserted to engage the holes of the interlocking member (41) and the holes of the hinged cross member (38) to create the hinge assembly (40). When the telescoping bracing support (21) is attached to the tree the weight of the tree causes the foot (39) to engage the floor and resist the weight thereby providing the bracing desired for the tree. Alternatively, all extension support assembly (25) and pivotable extension arm (2) can be shimmed or fitted with screw type leveling apparatus similar to table leg adjusters to accommodate floors that are not exactly level in the place where it is desirable to display the tree.

To use the stand (1) all of the telescoping bracing support (21) telescoping sections are set and locked in a neutral position which is midway of the telescoping range that makes the telescoping bracing supports (21) all the same length from the attachment point (20) to the tip of the end of the telescoping bracing support (21) that attaches to the tree trunk. When the stand (1) is to be attached while the tree is lying horizontally on the floor the integral reservoir (18) of the stand (1) or the floor of the detachable reservoir (27) should be kept in a position such that the trunk is substantially perpendicular to the floor of the integral reservoir (18) or the floor of the detachable reservoir (27). In order to minimize the adjustment of the telescoping bracing supports (21) during the initial phase of use, the spike assembly (32) is placed near the center of the cut end of the trunk, or the spike (42) is driven partially into the near center of the trunk with a hammer leaving an exposed portion. The center of the trunk is not visible once the invention is moved close enough so that the spike assembly (32) touches the point where it can enter the trunk or the hole that was drilled for display or use with a different type stand, to facilitate the location of the desired near center of the trunk a pilot hole for the spike (5) or the spike assembly (32) is created in the intended center of the trunk using a hammer and nail to partially drive the nail into the trunk and then remove the nail leaving the pilot hole. In this case the tip of the spike (5) or the tip of the spike assembly (32) is moved so that it finds the pilot hole or in cases where the tree has been drilled for display or for use with another type stand the spike (5) and the cam node (6) or the spike assembly (32) will be moved so that they find the drilled hole. A hammer is used to strike the underside of the stand (1) at the center to drive the spike into the near center of the cut end of the trunk. When the force of the hammer is applied, if the tree trunk has been drilled for display or for use with another type stand the tapered cam node (6) will engage the sides of the drilled hole. In the case where the stand (1) uses a detachable reservoir (27) without a spike assembly (32) as shown in FIG. 14 and as shown in FIG. 14 uses a spike (42) driven into the end of the trunk then the exposed end of the spike (42) is inserted into the center hole of the cam node (43). When the stand (1) is to be attached while the tree is placed vertically in the stand (1) the tree trunk is as near as possible placed so that the center of the trunk, or if there is a hole that has been drilled for display or use with another type of stand, is on the spike (5) and cam node (6) and the weight of the tree will cause the spike (5) to penetrate the end of the tree trunk and in the case of a tree trunk in which a hole has been drilled the cam node (6) to engage the side of the hole. It is obvious that in the case of using the stand (1) in a horizontal position that the tree must be rotated after attaching the first telescoping bracing support (21) such that the next and each other telescoping bracing support (21) can be attached to the tree. In the case where the stand (1) is attached to the tree in a vertical position then once the first telescoping bracing support (21) has been attached then the user must move around the tree such that the next and each other telescoping bracing support (21) can be attached to the tree.

For attaching the tree in a horizontal or vertical position, in the event that there are locations around the trunk that all of the telescoping bracing supports (21) can be attached without interference from a branch then the telescoping bracing supports (21) will be attached by removable attachment means such as wood screws (15) substantially equidistant around the trunk in a nearly vertical position without changing the lengths of the telescoping bracing supports (21). In the event that any one of the telescoping bracing supports (21) cannot engage the tree without interference from a branch, then the releasable locking mechanism (11) of that telescoping bracing support (21) can be disengaged and the telescoping bracing support (21) shortened and then the releasable locking mechanism (11) reapplied so that the swivel hinge (7) can be attached immediately underneath the interfering branch. While keeping the trunk still substantially perpendicular to the stand (1), the swivel hinge (7) of the telescoping bracing supports (21) will be attached using removable attachment means such as wood screws (15) inserted through the holes provided. In an instance where there is a location around the trunk that all of the telescoping bracing supports (21) can be attached, then alternatively in those cases the telescoping bracing supports (21) can be attached by inserting the retainer lip (37) of the swivel hinge (7) under a collar (35) similar to an adjustable band clamp which has been fastened around the trunk of the tree at the height sufficient to allow the telescoping bracing supports (21) to brace the tree.

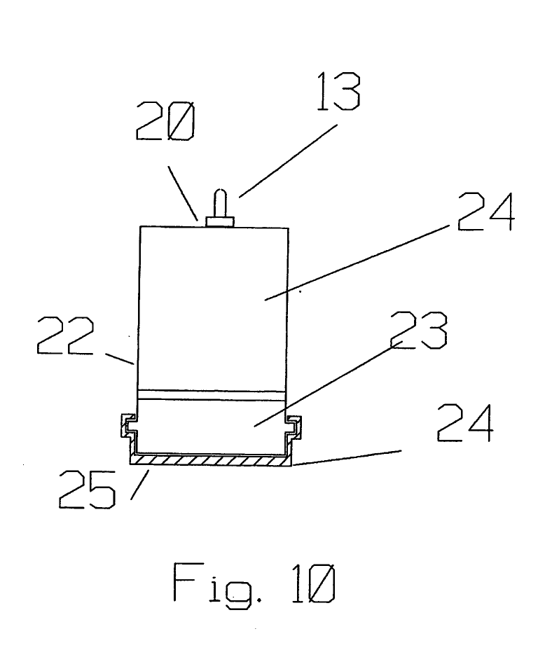

If the stand (1) was attached in a horizontal position the tree is tilted up so that the bottom side of the stand (1) is resting on the floor and the tree is in a more vertical position. At this point the pivotable extension arm (2) as shown in FIGS. 2 and 3, or the base extension (24) as shown in FIGS. 10, 11 and 12 can be partially or fully deployed. If the position of the tree is not as vertical as desired, the releasable locking mechanism (11) of any telescoping section of each telescoping bracing support (21) can be unlocked and the tree can be freely moved to the vertical position that is desired and the releasable locking mechanism (11) of each telescoping bracing support (21) telescoping section can each be locked thereby retaining the position selected. The free moving of the tree that has been attached to the stand (1) is accomplished due to the pivot point created by the spike (5) and the clearance from the bottom of the floor of the stand (1) created by the tapered cam node (6) and the swivel attachments on each end of the telescoping bracing support (21) as shown in FIG. 6. The moving of the tree in a direction away from one or more of the telescoping bracing supports (21) causes the lengthening of the telescoping bracing support (21) and the shortening of other telescoping bracing supports (21) correspondingly changing the angle at which each telescoping bracing support (21) provides bracing for the tree.

Once the tree has been placed in the desired vertical position and the releasable locking mechanism (11) has been applied to each of the telescoping bracing supports (21) telescoping sections a quick release pin can be inserted into the hole (10) nearest to the end of each the telescoping tube inner member (8) to prevent the moving of the tree from the desired vertical position in the event that any of the releasable locking mechanism (11) is accidentally released.

The following embodiments of the present invention describe a much improved display device which allows a stable easily adjustable display method with significantly increased water supply from a reservoir. The only tools required by the invention are a screwdriver and a hammer and all parts are inexpensive to manufacture and reusable for an indefinite period of time.

The present invention provides a system whereby the bracing attachment points at the tree trunk are determined without regard to the availability of branches sufficiently strong to withstand the tension necessary to secure trees of various sizes to the base members. Since great care is taken in the growing and shaping of the Christmas tree to present as uniform of an appearance as possible an additional benefit is that there is no unwanted re-positioning of the branches by the downward bending caused by the forces from any attachment method using the branches as a connection point.

A further advantage of the present invention is that the amount of free play in the range of telescoping of each telescoping members is sufficient to allow the ends of the bracing support members to be attached approximately equidistant around the trunk while being attached to the tree at a height different than other telescoping members, thereby allowing the user to avoid removing significant branches which interfere with a telescoping members while providing the necessary angle of bearing to brace the tree.

A further advantage of the present invention is that the tree is firmly and securely attached to the invention and does not rely on ball sockets and other swivel means at the point of attachment to attempt to adjust the tree to vertical. The present invention achieves vertical adjustment by changing the lengths and thereby the angles of the unlocked telescoping bracing supports telescoping section by allowing the lengthening and shortening of any of the bracing supports to occur in harmony with other unlocked telescoping bracing supports while maintaining connection to the selected point of attachment to the Christmas tree. The preferred vertical adjustment is retained by applying a locking mechanism to each of the telescoping bracing supports telescoping sections.

A further advantage of the present invention is that the attached and locked telescoping bracing supports act in harmony with each other to provide anchor points that resist twisting of the tree and the telescoping bracing supports can be readjusted in the event that the moving of the tree to a different location causes the initial desired adjustment to be altered.

A further advantage of the present invention is that the water level of the reservoir is more easily monitored and maintained through use of an external sight glass (26) as shown in FIG. 13 to indicate the level of the water in the reservoir. The sight glass can be fitted with an audio or visual type alarm which can alert a user when the water level is at a predetermined low level.

A further advantage of the present invention is that the use of removable attachment means such as screws to attach the end of the telescoping bracing supports to the tree allows a user to detach and remove the tree from the invention at the end of the season while the tree is still upright, thereby leaving the reservoir and any unused water to be disposed of separately from the tree without spills due to tipping of the tree.

A further advantage of the present invention is that as shown in FIG. 15 many types of inverted conical shaped existing Christmas tree stands (43) can be attached to the cross members (38) and used as a separate reservoir. The telescoping bracing supports (21) of the present invention can then be used to provide the desired higher contact point up the tree trunk and provide the ability to more easily adjust and lock the tree in the desired display vertical display position.

What is claimed is:

1. A stand for a tree comprising:
a base having a top portion;
a plurality of attachment points coupled to said top portion along its circumferential periphery; and
a plurality of telescoping bracing supports, each telescoping bracing support comprising:
a first end;
wherein said first end is coupled to one of said plurality of attachment points;
a second end;
wherein said second end is equipped to engage an outer portion of said tree;
at least one inner member;
at least one outer member;
wherein said at least one inner member is slidably coupled to said at least one outer member with a releasable locking mechanism; and
a spike assembly disposed between the bottom of the base and the tree and arranged to impale said tree at its base and engage the base.

2. The stand of claim 1 further comprising a reservoir.

3. The stand of claim 2, wherein the reservoir is integral with the base.

4. The stand of claim 3, wherein the reservoir is equipped with a sight glass.

5. The stand of claim 2, wherein the reservoir is separate from the base.

6. The stand of claim 5, wherein the reservoir is equipped with a sight glass.

7. The stand of claim 1, wherein said plurality of telescoping bracing supports is equipped with a swivel hinge at said first end and at said second end.

8. The stand of claim 7, wherein said second end swivel hinge is equipped with at least one hole to fasten said swivel hinge to said tree.

9. The stand of claim 8, wherein said second end swivel hinge is further equipped with a clamping means chosen from a C-type and band clamp.

10. The stand of claim 7, wherein said second end is coupled to a collar around the circumference of said tree.

11. The stand of claim 7, wherein each said plurality of telescoping bracing supports is equipped with a swivel hinge at said first end.

12. The stand of claim 1, wherein the base further comprises an extension support assembly.

13. The stand of claim 11, wherein the extension support assembly comprises:
an extension rail; and
a base extension slidably coupled to said extension rail.

14. The stand of claim 11, wherein the extension support assembly comprises a pivotable extension arm coupled to said base.

15. The stand of claim 11, wherein the extension support assembly comprises retractable telescoping legs coupled to said base.

16. The stand of any one of claims 12 through 14, wherein the support assembly is further equipped with a leveling mechanism.

17. The stand of claim 1, wherein a plurality of holes are provided longitudinally along said outer member for the placement of a pin to further secure the relative position of said inner member and said outer member.
